(19) United States
(12) Patent Application Publication
(10) Pub. No.: US 2024/0027232 A1
(43) Pub. Date: Jan. 25, 2024

(54) Inductive Position Sensor and Device

(71) Applicant: Robert Bosch GmbH, Stuttgart (DE)

(72) Inventors: Andreas Kurz, Bietigheim (DE); Robert Alexander Dauth, Heilbronn (DE); Sina Fella, Neuenstadt (DE); Tim Krzyzanowski, Lauffen Am Neckar (DE)

(21) Appl. No.: 18/256,922

(22) PCT Filed: Dec. 9, 2021
(86) PCT No.: PCT/EP2021/084938

§ 371 Date: Jun. 12, 2023

(30) Foreign Application Priority Data
Dec. 17, 2020 (DE) 10 2020 216 144.5

(51) Int. Cl. G01D 5/20

(52) U.S. Cl. CPC G01D 5/2053

(57) ABSTRACT

An inductive position sensor includes (i) a coupling element which can be arranged on a movable element, (ii) at least one sensor unit for detecting a position of the coupling element, the sensor unit having at least one controllable transmitter coil for generating electromagnetic waves and at least one receiver coil for detecting the electromagnetic waves generated by the transmitter coil and influenced by the coupling element, and (iii) a printed circuit board having a plurality of layers. The coils of the sensor unit are formed on the printed circuit board. The transmitter coil and the receiver coil are distributed on the layers of the printed circuit board in such a way that at least some sections of the transmitter coil are axially opposite the receiver coil with respect to an axis oriented perpendicularly to the printed circuit board.

The invention relates to an inductive position sensor, comprising a coupling element which can be arranged on a movable element, comprising at least one sensor unit for detecting a position of the coupling element, the sensor unit having at least one controllable transmitter coil for generating electromagnetic waves and at least one receiver coil for detecting the electromagnetic waves generated by the transmitter coil and influenced by the coupling element, and comprising a printed circuit board having a plurality of layers, the coils of the sensor unit being formed on the printed circuit board.

Furthermore, the invention relates to a device having an inductive position sensor.

### PRIOR ART

Inductive position sensors are already known in the prior art. An inductive position sensor usually has a sensor unit which has at least one controllable transmitter coil for generating electromagnetic waves. The generated waves are influenced by a coupling element of the position sensor, and the influenced waves are detected by at least one receiver coil of the sensor unit. Inductive position sensors utilize the effect whereby the waves generated by the transmitter coil are influenced differently by the coupling element depending on the position of the coupling element. Accordingly, the waves detected by the receiver coil are also influenced by the position of the coupling element. Accordingly, the position of the coupling element can be determined or detected on the basis of the electromagnetic waves detected by the receiver coil. If the coupling element is arranged on a movable element, the position of the movable element can be indirectly determined by determining the position of the coupling element. Typically, the transmitter coil and the receiver coil are formed on a common, multi-layer printed circuit board of the position sensor.

An inductive position sensor of the type mentioned at the outset is known, for example, from patent application DE 10 2016 202 871 B3. In this known position sensor, the transmitter coil and the receiver coil are distributed on the plurality of layers of the printed circuit board in such a way that the transmitter coil radially surrounds the receiver coil with respect to an axis oriented perpendicularly to the printed circuit board.

### DISCLOSURE OF THE INVENTION

The inductive position sensor according to the invention is characterized by the features according to claim 1, whereby the transmitter coil and the receiver coil are distributed on the layers of the printed circuit board in such a way that at least some sections of the transmitter coil are axially opposite the receiver coil with respect to the axis oriented perpendicularly to the printed circuit board. The design of the position sensor according to the invention makes it possible to reduce the size of the transmitter coil in the radial direction compared with known position sensors. As a result, the position sensor can be designed to be smaller overall without thereby reducing the sensitivity of the sensor unit. In addition, the design of the position sensor according to the invention provides a larger variation range for adjusting the inductance of the transmitter coil. This is largely determined by the geometry of the transmitter coil and the distance between the transmitter coil and the coupling element. Preferably, the position sensor has a computing unit which is designed to evaluate the electromagnetic waves detected by the receiver coil. For example, the computing unit is designed to demodulate the signal detected by the receiver coil, i.e. the detected waves. For this purpose, the computing unit is electrically connected to the receiver coil by electrical connecting lines. The computing unit is preferably designed to provide the demodulated signal to a control unit, wherein the control unit is designed to determine the position of the coupling element on the basis of the demodulated signal. Preferably, the computing unit is also designed to control the transmitter coil. For this purpose, the computing unit is electrically connected to the transmitter coil by electrical connecting lines. Particularly preferably, the computing unit is designed as an application-specific integrated circuit (ASIC). According to the invention, at least some sections of the transmitter coil are axially opposite the receiver coil. As such, at least one coil portion of the transmitter coil is axially opposite at least one coil portion of the receiver coil. The aforementioned connecting lines do not form a coil portion of the transmitter coil or the receiver coil. In this respect, the transmitter coil is not already axially opposite the receiver coil when the connecting lines via which the transmitter coil is connected to the computing unit are axially opposite the receiver coil. Accordingly, the receiver coil also does not already lie axially opposite the transmitter coil when the connecting lines via which the receiver coil is connected to the computing unit are axially opposite the transmitter coil.

According to a preferred embodiment, it is provided that the printed circuit board has at least one layer with no receiver coil, wherein a transmitter coil portion of the transmitter coil is formed on the layer with no receiver coil in such a way that the transmitter coil portion is axially opposite the receiver coil. This results in the advantage that the transmitter coil portion formed on the layer with no receiver coil can be sized independently of the size of the receiver coil. For example, a number of windings of the transmitter coil portion formed on the layer with no receiver coil can be selected independently of the size of the receiver coil.

According to a preferred embodiment, it is provided that the printed circuit board has at least one layer with no transmitter coil, wherein a receiver coil portion of the receiver coil is formed on the layer with no transmitter coil in such a way that the receiver coil portion is axially opposite the transmitter coil. This results in the advantage that the surface area of the receiver coil can be increased, such that ultimately an amplitude of the signal is increased. In addition, the receiver coil portion formed on the layer with no transmitter coil can be sized independently of the size of the transmitter coil. For example, a number of windings of the receiver coil portion formed on the layer with no transmitter coil can be selected independently of the size of the transmitter coil.

Preferably, the printed circuit board has at least one layer on which both the transmitter coil and the receiver coil are formed. On this layer, the transmitter coil and the receiver coil are accordingly radially opposite each other with respect to the axis oriented perpendicularly to the printed circuit board.

Preferably, the transmitter coil and the receiver coil are each formed on different layers of the printed circuit board. In this respect, the transmitter coil is formed only on layers with no receiver coil and the receiver coil is formed only on layers with no transmitter coil. Accordingly, the transmitter coil and the receiver coil are axially spaced apart from each other with respect to the axis oriented perpendicularly to the printed circuit board. This results in the advantage that the geometries of the transmitter coil and the receiver coil can be selected independently of one another.

According to a preferred embodiment, it is provided that the transmitter coil is arranged on a side of the receiver coil facing away from the coupling element. The receiver coil is accordingly arranged between the coupling element and the transmitter coil. With such an arrangement of the coils, the sensor unit has a particularly high sensitivity. According to an alternative embodiment, it is preferably provided that the receiver coil is arranged on a side of the transmitter coil facing away from the coupling element. The transmitter coil is then arranged between the coupling element and the receiver coil.

According to a preferred embodiment, it is provided that the receiver coil has a maximum radial extension which corresponds at least substantially to a maximum radial extension of the transmitter coil. With such a configuration of the coils, the installation space present on the printed circuit board is utilized as optimally as possible, as a result of which the amplitude of the signal is maximized. A radial extension is to be understood as an extension which runs perpendicularly to the axis. All possible radial extensions accordingly run parallel to the layers of the printed circuit board.

Preferably, the printed circuit board is circular-disk-shaped, in particular annular-disk-shaped or strip-shaped. If the position sensor is designed as a rotational angle sensor, the printed circuit board is preferably designed in the shape of a circular disk. The position sensor designed as a rotational angle sensor is designed to detect a rotational position or a rotational angle of the coupling element as the position of the coupling element. However, if the position sensor is designed as a linear travel sensor, the printed circuit board is preferably formed in a strip shape. The position sensor designed as a linear travel sensor is designed to detect a displacement position of the coupling element as the position of the coupling element.

According to a preferred embodiment, the sensor unit has at least two receiver coils, wherein the receiver coils are formed on the same layers of the printed circuit board. The sensor unit therefore has a first receiver coil and a second receiver coil. In this case, the receiver coils are preferably designed or arranged such that the first receiver coil detects a sinusoidal signal and the second receiver coil detects a cosinusoidal signal. If the position sensor is designed as a rotational angle sensor, the rotational angle of the coupling element can then be determined by determining the arc tangent (sin/cos).

Preferably, the position sensor has a further sensor unit for detecting a position of a further coupling element, wherein the further sensor unit has at least one transmitter coil and at least one receiver coil, and wherein the coils of the further sensor unit are formed on the printed circuit board. In such a configuration, the position sensor can be used as a torque and angle sensor (TAS). In this case, the coupling element and the further coupling element are then connected in a rotationally fixed manner to the same shaft, and the printed circuit board is arranged between the coupling element on the one hand and the further coupling element on the other hand. The position sensor designed as a torque and angle sensor is then designed to detect both a torque generated by the shaft and a rotational angle of the shaft.

According to a preferred embodiment, it is provided that the transmitter coil of the sensor unit and the transmitter coil of the further sensor unit are surrounded axially by the receiver coil of the sensor unit on the one hand and the receiver coil of the further sensor unit on the other hand. The transmitter coils are therefore arranged between the receiver coils. The two sensor units then have a particularly high sensitivity. According to an alternative embodiment, it is preferably provided that the receiver coil of the sensor unit and the receiver coil of the further sensor unit are surrounded axially by the transmitter coil of the sensor unit on the one hand and the transmitter coil of the further sensor unit on the other hand.

The device according to the invention has a movable element and an inductive position sensor for detecting a position of the movable element. The device is characterized according to the features of claim 12 by the design of the position sensor according to the invention. This also results in the advantages already mentioned. Further preferred features and combinations of features are found in the description and in the claims. For detecting the position of the element, the coupling element is arranged directly or indirectly on the element. Preferably, the device is designed as a drive device. The movable element is then an actuator element of the drive device. The actuator element is preferably mounted rotatably or displaceably. If the actuator element is rotatably mounted, the position sensor is designed as a rotational angle sensor. If the actuator element is mounted displaceably, the position sensor is designed as a linear travel sensor. According to a further embodiment, the element is, for example, an actuatable pedal. The position sensor is then designed as a pedal travel sensor.

The invention is explained in more detail below with reference to the drawings. In the drawings:

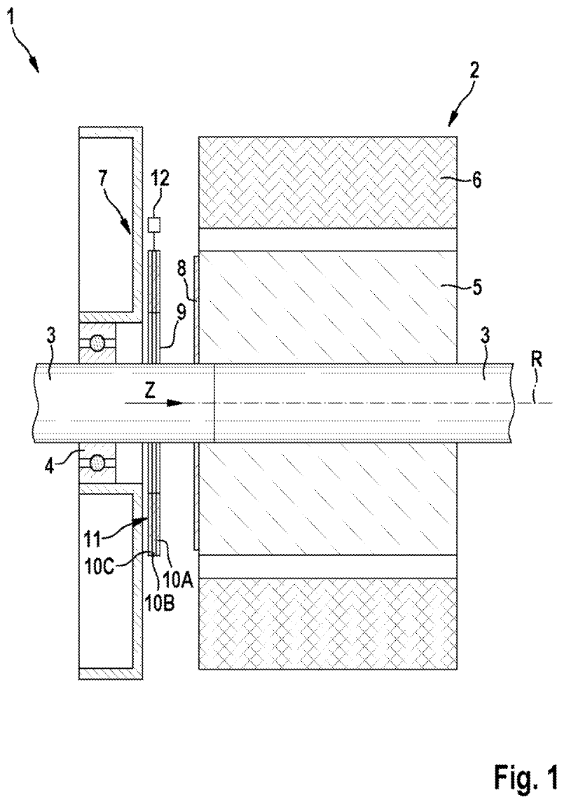

FIG. 1 shows a drive device having an inductive position sensor,

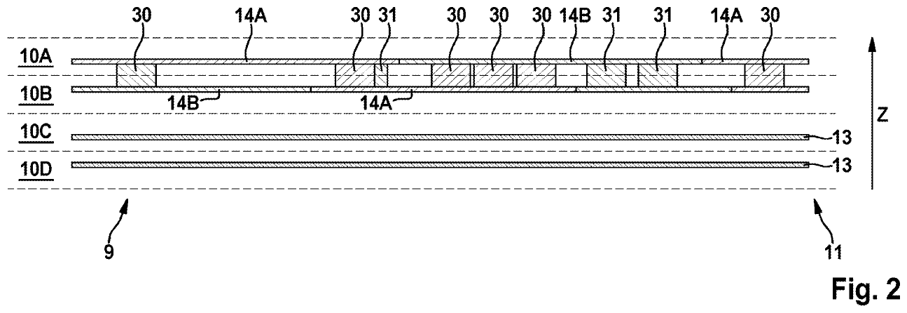

FIG. 2 shows a printed circuit board of the position sensor according to a first embodiment,

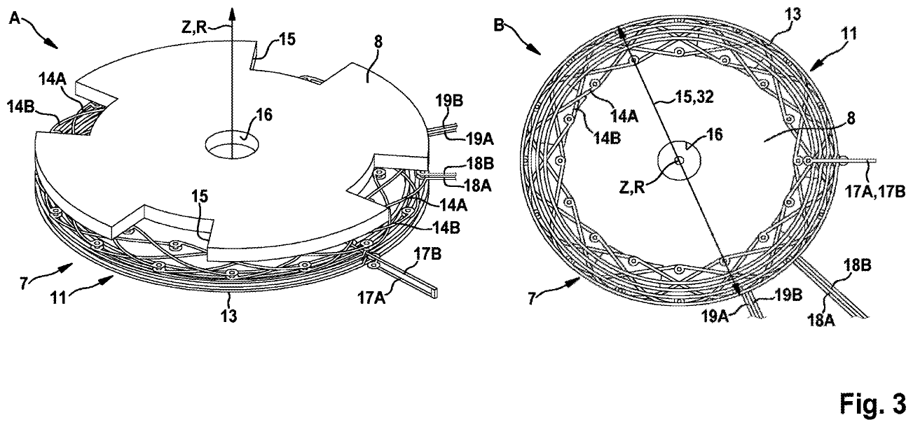

FIG. 3 shows further illustrations of the position sensor according to the first embodiment,

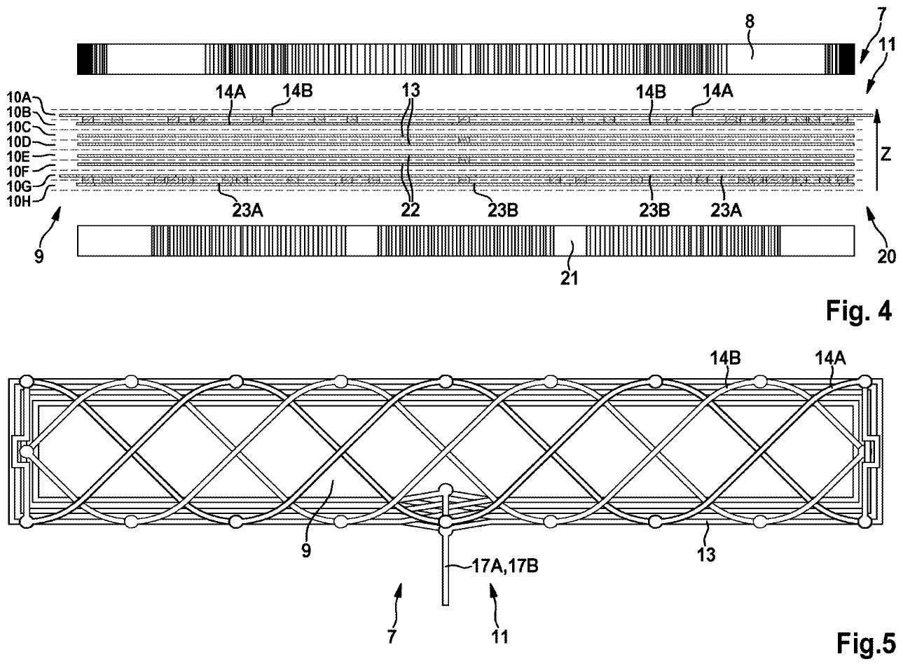

FIG. 4 shows a printed circuit board of the position sensor according to a second embodiment, and

FIG. 5 shows the position sensor according to a third embodiment.

FIG. 1 shows a simplified illustration of an advantageous drive device 1 for a consumer which is not shown in further detail here, for example, a brake system, in particular a parking brake, of a motor vehicle.

The drive device 1 has an electric machine 2. The machine 2 has a rotatably mounted drive shaft 3 as an actuator element. In the present case, a bearing 4 which transmits a radial force is provided for mounting the shaft. The drive shaft 3 carries a rotor 5 which is associated with a stator 6 fixed to the housing. The rotor 5 and thus the drive shaft 3 can be made to rotate by a suitable energization of a stator winding (not shown) of the stator 6. The drive shaft 3 is or can be mechanically coupled to the consumer in order to drive same.

The drive device 1 also has an inductive position sensor 7 associated with the machine 2. The position sensor 7 has a coupling element 8 which is connected to the drive shaft 3 in a rotationally fixed manner. The coupling element 8 is thus rotatable with the drive shaft 3.

The position sensor 7 also has a printed circuit board 9. The printed circuit board 9 is arranged so as to be fixed to the housing such that the printed circuit board 9 and the drive shaft 3 are rotatable relative to one another. The coupling element 8 is axially opposite the printed circuit board 9 with respect to an axis Z which is oriented perpendicularly to the printed circuit board 9. In the present case, the printed circuit board 9 is arranged or aligned in such a way that the axis Z runs parallel to the axis of rotation R of the drive shaft 3.

The printed circuit board 9 has a plurality of layers 10. In the present case, a first layer 10A, a second layer 10B and a third layer 10C are shown. However, the printed circuit board 9 can also have a different, in particular larger, number of layers 10. The layers 10 are arranged axially one behind the other with respect to the axis Z. The first layer 10A faces the coupling element 8 and is also referred to below as the uppermost layer 10A. Adjoining it, at further distances from the coupling element 8 in each case, are the second layer 10B and the third layer 10C.

The position sensor 7 also has a sensor unit 11. The sensor unit 11 has a plurality of coils, which are not shown in FIG. 1 for reasons of clarity. The coils are formed on the layers 10 of the printed circuit board 9, preferably as conductor tracks. At least one controllable transmitter coil and at least one receiver coil are provided.

The position sensor 7 also has a computing unit 12, which according to the present embodiment is designed as an application-specific integrated circuit (ASIC). The computing unit 12 is shown only schematically in FIG. 1. Preferably, the computing unit 12 is also formed on the printed circuit board 9. The computing unit 12 is electrically connected to the transmitter coil and is designed to control the transmitter coil to transmit a signal, by means of electromagnetic waves, that penetrates the coupling element 8. The electromagnetic waves are influenced by the coupling element 8, reflected or guided to the receiver coil, and detected by the receiver coil. The electromagnetic waves are influenced differently by the coupling element 8 depending on the rotational position or the rotational angle of the coupling element 8. Correspondingly, different electromagnetic waves are detected by the receiver coil at different rotational angles of the coupling element 8. The computing unit 12 is electrically connected to the receiver coil and is designed to demodulate the detected electromagnetic waves. The computing unit 12 has a communication connection to a control unit (not shown), wherein the control unit is designed to determine the rotational angle of the coupling element 8 on the basis of the demodulated waves. Due to the rotationally fixed connection of the coupling element 8 to the drive shaft 3, the rotational angle of the drive shaft 3 correlates with that of the coupling element 8. If the control unit determines the angle of rotation of the coupling element 8, the control device thus indirectly determines the rotational angle of the drive shaft 3.

A first embodiment of the position sensor 7 is explained in more detail below with reference to FIGS. 2 and 3.

FIG. 2 shows a sectional illustration of a section of the printed circuit board 9. According to the first embodiment of the position sensor 7, the printed circuit board 9 has four layers 10, namely a first layer 10A facing the coupling element 8, a second layer 10B, a third layer 10C and a fourth layer 10D.

The sensor unit 11 has a transmitter coil 13, as well as a first receiver coil 14A and a second receiver coil 14B. The transmitter coil 13 on the one hand and the receiver coils 14A, 14B on the other hand are each formed on different layers 10 of the printed circuit board 9. In the present case, the transmitter coil 13 is formed on the third layer 10C and the fourth layer 10D. The receiver coils 14A, 14B are both formed on the first layer 10A and the second layer 10A. The transmitter coil 13 is therefore formed only in layers with no receiver coils 10C, 10D. Accordingly, the receiver coils 14A, 14B are formed only in layers with no sensor coils 10A, Each of the transitions from one layer 10 to an adjacent layer 10 is achieved by a via. FIG. 2 shows a plurality of vias 30 by which the first receiver coil 14A transitions from the first layer into the second layer 10B, as well as a plurality of vias 31 by which the second receiver coil 14B transitions from the first layer 10A into the second layer 10B.

Due to the formation of the transmitter coil 13 and the receiver coils 14A, 14B each on different layers 10 of the printed circuit board 9, the transmitter coil 13 is axially spaced apart from the receiver coils 14A, 14B with respect to the axis Z. In this case, at least some sections of the transmitter coil 13 are axially opposite the receiver coils 14A, 14B with respect to the axis Z. The transmitter coil 13 and the receiver coils 14A, 14B thus lie at least in sections at the same height radially with respect to the axis Z.

In the present case, the receiver coils 14A, 14B are formed in the two upper layers 10A and 10B of the printed circuit board 9. The transmitter coil 13 is thus formed on a side of the receiver coils 14A, 14B facing away from the coupling element 8, so that the receiver coils 14A, 14B are arranged between the coupling element 8 and the transmitter coil 13.

FIG. 3 shows further illustrations of the position sensor 7 according to the first embodiment. The left-hand illustration A shows a perspective view of the position sensor 7. The right-hand illustration B shows a plan view of the position sensor 7.

As can be seen from illustration A, the coupling element 8 is circular-disk-shaped. In this case, the circular disk shape of the coupling element 8 has a plurality of measuring recesses 15 which are formed in the coupling element 8 so as to be distributed in the circumferential direction of the coupling element 8. In particular, the measuring recesses 15 ensure that the electromagnetic waves emitted by the transmitter coil 13 are influenced differently by the coupling element 8 depending on the rotational angle of the coupling element 8. The coupling element 8 also has a central axial passage 16. In this respect, the coupling element 8 is designed in the shape of an annular disk. If the coupling element 8 is connected to a shaft in a rotationally fixed manner as shown in FIG. 1, the shaft extends through the central axial passage 16 of the coupling element 8.

As can be seen from illustration B, the transmitter coil 13 is annular and has a plurality of windings concentric to one another. The receiver coils 14A, 14B are also in each case at least substantially annular. In this case, the receiver coils 14A, 14B have an undulating profile in the circumferential direction of the respective annular shapes. The transmitter coil 13 and the receiver coils 14A, 14B are arranged coaxially with one another.

In the present case, the transmitter coil 13 and the receiver coils 14A, 14B are sized such that a maximum radial extension 15 of the transmitter coil 13 corresponds at least substantially to a maximum radial extension 32 of the receiver coils 14A, 14B. The maximum radial extension 15 or 32 corresponds to the diameter of the relevant annular shape.

The printed circuit board 9 is not shown in FIG. 3. However, the printed circuit board 9 is also designed in the shape of an annular disk. In this respect, the printed circuit board 9 also has a central axial passage. In this case, a diameter of the central axial passage of the printed circuit board 9 is sized such that the drive shaft 3 can pass through the axial passage in a contactless manner.

The transmitter coil 13 is electrically connected to the computing unit 12 by two electrical connecting lines 17A, 17B. Starting from the transmitter coil 13, the connecting lines 17A, 17B run radially outwards for the purpose of contacting the computing unit 12. The receiver coil 14A is electrically connected to the computing unit 12 by two electrical connecting lines 18A, 18B. Starting from the receiver coil 14A, the connecting lines 18A, 18B run radially outwards for the purpose of contacting the computing unit 12. The receiver coil 14B is electrically connected to the computing unit 12 by two electrical connecting lines 19A, 19B. Starting from the receiver coil 14B, the connecting lines 19A, 19B run radially outwards for the purpose of contacting the computing unit 12.

A second embodiment of the position sensor 7 is explained in more detail below with reference to FIG. 4. For this purpose, FIG. 4 shows a sectional view of the position sensor 7 according to the second embodiment.

According to the embodiment shown in FIG. 4, the position sensor 7 is designed as a torque and angle sensor. In this respect, the position sensor 7 is designed to detect both a rotational angle of a shaft and a torque generated by the shaft. For this purpose, the position sensor 7 has a further sensor unit 20 in addition to the sensor unit 11.

According to the embodiment shown in FIG. 4, the printed circuit board 9 has eight layers, namely a first layer 10A, a second layer 10B, a third layer 10C, a fourth layer 10D, a fifth layer 10E, a sixth layer 10F, a seventh layer 10G and an eighth layer 10H. The coils 13, 14A, 14B of the sensor unit 11 are formed as in the first embodiment on the layers 10A to 10D.

The further sensor unit 20 also has a transmitter coil 22 and two receiver coils 23A, 23B. The transmitter coil 22 is formed on the fifth layer 10E and the sixth layer 10F of the printed circuit board 9. The receiver coils 23A, 23B are formed together on the seventh layer 10G and the eighth layer 10H of the printed circuit board 9. In this respect, the transmitter coils 13 and 22 are surrounded axially by the receiver coils 14A, 14B on the one hand and the receiver coils 23A, 23B on the other hand. In this case, the transmitter coil 22 and the receiver coils 23A, 23B are also formed on the layers 10 of the printed circuit board 9 in such a way that the transmitter coil 22 is axially opposite the receiver coils 23A, 23B with respect to the axis Z. Preferably, the further sensor unit 20 is formed mirror-symmetrically to the sensor unit 11 in relation to a plane running between the transmitter coil 13 on the one hand and the transmitter coil 22 on the other hand.

The further sensor unit 20 is associated with a further coupling element 21, which, with regard to its design, preferably corresponds to the coupling element 8. The further coupling element 21 is arranged on a side of the printed circuit board 9 facing away from the coupling element 8. The printed circuit board 9 is thus surrounded axially by the coupling elements 8 and 21.

A third embodiment of the position sensor 7 is explained in more detail below with reference to FIG. 5. For this purpose, FIG. 5 shows a plan view of the position sensor 7. According to the third embodiment, the position sensor 7 is designed as a linear travel sensor for a displaceably mounted linear actuator element of an electric machine. In this respect, the position sensor 7 is designed to detect a displacement position of a coupling element arranged on the linear actuator element. For this purpose, the printed circuit board 9 is not designed in the shape of an annular disk, but rather is formed in a strip shape. The transmitter coil 13 is rectangular in shape and extends in the longitudinal direction of the printed circuit board 9. The receiver coils 14A, 14B also extend in the longitudinal direction of the printed circuit board 9. Otherwise, in the embodiment shown in FIG. 5, the transmitter coil 13 and the receiver coils 14A, 14B are also distributed on the layers 10 of the printed circuit board 9 in such a way that at least some sections of the transmitter coil 13 are axially opposite the receiver coils.

In the embodiments described above, the transmitter coil and the receiver coils are always formed on different layers 10 of the printed circuit board 9. According to a further embodiment, the printed circuit board 9 has at least one layer 10 on which at least one transmitter coil and at least one receiver coil are formed together.

1. An inductive position sensor comprising:
a coupling element configured to be arranged on a movable element;
at least one sensor unit configured to detect a position of the coupling element, the at least one sensor unit having at least one controllable transmitter coil configured to generate electromagnetic waves and at least one receiver coil configured to detect the electromagnetic waves generated by the transmitter coil and influenced by the coupling element; and
a printed circuit board having a plurality of layers, the coils of the sensor unit being formed on the printed circuit board,
wherein the transmitter coil and the receiver coil are distributed on the layers of the printed circuit board in such a way that at least some sections of the transmitter coil are axially opposite the receiver coil with respect to an axis oriented perpendicularly to the printed circuit board.

2. The position sensor according to claim 1, wherein:
the printed circuit board has at least one layer with no receiver coil, and wherein
a transmitter coil portion of the transmitter coil is formed on the layer with no receiver coil in such a way that the transmitter coil portion is axially opposite the receiver coil.

3. The position sensor according to claim 1, wherein:
the printed circuit board has at least one layer with no transmitter coil, and wherein
a receiver coil portion of the receiver coil is formed on the layer with no transmitter coil in such a way that the receiver coil portion is axially opposite the transmitter coil.

4. The position sensor according to claim 1, wherein the printed circuit board has at least one layer on which both the transmitter coil and the receiver coil are formed.

5. The position sensor according to claim 1, wherein the transmitter coil and the receiver coil are each formed on different layers of the printed circuit board.

6. The position sensor according to claim 5, wherein:
the transmitter coil is arranged on a side of the receiver coil facing away from the coupling element, or
the receiver coil is arranged on a side of the transmitter coil facing away from the coupling element.

7. The position sensor according to claim 1, wherein the receiver coil has a maximum radial extension corresponding at least substantially to a maximum radial extension of the transmitter coil.

8. The position sensor according to claim 1, wherein the printed circuit board is circular-disk-shaped.

9. The position sensor according to claim 1, wherein:
the sensor unit has at least two receiver coils, and
the receiver coils being are formed on the same layers of the printed circuit board.

10. The position sensor according to claim 1, further comprising a further sensor unit for detecting configured to detect a position of a further coupling element, wherein:
the further sensor unit has at least one transmitter coil and at least one receiver coil, and
the coils of the further sensor unit are formed on the printed circuit board.

11. The position sensor according to claim 10, wherein the transmitter coil of the sensor unit and the transmitter coil of the further sensor unit are surrounded axially on the one hand by the receiver coil of the sensor unit, and on the other hand by the receiver coil of the further sensor unit.

12. A device, comprising:
a movable element; and
an inductive position sensor associated with the movable element for the purpose of detecting a position of the movable element,
wherein the design of the inductive position sensor is according to claim 1.

13. The position sensor according to claim 1, wherein the printed circuit board is annular-disk-shaped, or strip-shaped.
